(19) United States
(12) Patent Application Publication
(10) Pub. No.: US 2012/0082785 A1
(43) Pub. Date: Apr. 5, 2012

(54) BIAXIALLY ORIENTED POLYESTER FILM AND PREPARATION METHOD THEREOF

(75) Inventors: Nam Ill Kim, Suwon-si (KR); Soo Hee Kim, Siheung-si (KR); Sung Jun Yoon, Suwon-si (KR)

(73) Assignee: SKC CO., LTD., Suwon-si, Gyeonggi-do (KR)

(21) Appl. No.: 13/376,931

(22) PCT Filed: Jun. 9, 2010
(86) PCT No.: PCT/KR2010/003693

§ 371 Date: Dec. 8, 2011

(30) Foreign Application Priority Data
Jun. 9, 2009 (KR) 10-2009-0051129
Jun. 9, 2009 (KR) 10-2009-0051135

(51) Int. Cl. B05D 7/24; C08L 67/02; C08K 5/3475; B29C 47/88; C08K 5/132; C08G 63/189; C08G 63/672; C08G 63/183; C08K 5/17

(52) U.S. Cl. 427/209; 528/308.6; 524/605; 524/91; 524/236; 524/336; 528/298; 524/604; 528/301; 528/302; 264/210.7

(57) ABSTRACT

A back sheet for a solar cell, consisting of a polyester comprising at least one repeating unit of trimethylene naphthalate and trimethylene terephthalate in an amount of 85% by weight or more, has improved hydrolysis-resistance and is useful in the field requiring weatherability.

### FIELD OF THE INVENTION

The present invention relates to a biaxially oriented polyester film and a preparation method thereof, more particularly, to a back sheet used as a surface protective layer or a reflective layer of a solar cell, and a preparation method thereof.

### BACKGROUND OF THE INVENTION

There have been a number of efforts to develop new and renewable energies for solving the depletion of petroleum resources and the environmental pollution. Among others, commercial solar cells have been extensively developed and their development and utilization are expected to grow further. A solar cell consists of a surface protective layer, an inner cell layer, and a reflective layer, and is required to have a long lifetime of 20 to 30 years. As the surface protective layer, a tempered glass having high transmission and excellent weatherproof properties has been employed, but, in spite of its high surface hardness, it is fragile and heavy, and the process of using such a tempered glass in the preparation of a solar cell is complicated. Also, as the reflective layer, a thick fluorine-based resin polyvinyl fluoride (PVF) film has been used, but the cost for processing such a film to make a back sheet is high. Therefore, there is a need to develop novel material having excellent weatherability and easy processability which can be used in the back sheet application at a low manufacturing cost.

A biaxially oriented film manufactured from polyethylene terephthalate (PET) has been widely used in a variety of applications due to its desirable characteristics such as good processability and comparatively low cost, but it is not suitable for outside uses over a long period due to its poor weatherability. In particular, the film has poor UV stability and low hydrolytic resistance, which makes it unsuitable for use in outdoor applications such as the back sheet for a surface protective layer and a thick reflective layer of a solar cell. The UV stability may be improved by the addition of UV stabilizers, but the poor hydrolytic resistance cannot be resolved by simple methods.

Japanese Laid-open Patent Publications Nos. 2001-111073 and 2007-253463 proposes a method of protecting a PET film having poor hydrolytic resistance from moisture by forming an inorganic oxide film deposited on the PET film so as to enhance the hydrolytic resistance of the PET film. However, such method causes a significant increase in the manufacturing cost owing to the inorganic oxide deposition process, and the durability of the weather resistance of such an inorganic oxide-deposited layer for more than twenty years has not been established.

The present inventors have examined a method of preparing a film having a high polymerization degree, corresponding to an intrinsic viscosity (IV) of more than 0.8, by typical solid-state polymerization of raw resins, and also a method of lowering the hydroxyl end group (OH) or carboxyl end group (COOH) content, but have found that the films made by such methods are not sufficiently resistant to hydrolytic degradation.

Accordingly, the present inventors have investigated to solve the above-mentioned problems, and have succeeded in developing a back sheet for a solar cell having improved properties to satisfy economic feasibility, processability, and hydrolysis-resistance.

### SUMMARY OF THE INVENTION

Therefore, it is an object of the present invention to provide a novel back sheet for a solar cell, which has excellent weatherability by improving the hydrolysis-resistance, and a preparation method thereof.

In accordance with one aspect of the present invention, there is provided a back sheet for a solar cell, consisting of a polyester comprising at least one repeating unit of trimethylene naphthalate and trimethylene terephthalate in an amount of 85% by weight or more.

In accordance with another aspect of the present invention, there is provided a method for preparing a back sheet for a solar cell, comprising a) subjecting a polyester resin containing at least one repeating unit of trimethylene naphthalate and trimethylene terephthalate in an amount of 85% by weight or more to melt-extrusion and quenching, to obtain an undrawn sheet; b) drawing the undrawn sheet in the longitudinal and transverse directions and heat-set with relaxation to obtain a biaxially oriented sheet; and c) cooling the biaxially oriented sheet.

### DETAILED DESCRIPTION OF THE INVENTION

Hereinafter, the present invention is described in detail.

The back sheet for a solar cell in accordance with the present invention is characterized in consisting of polyester comprising at least one repeating unit of trimethylene naphthalate and trimethylene terephthalate in an amount of 85% by weight or more. When the amount of the repeating unit is less than 85% by weight, desired hydrolysis-resistance cannot be accomplished. The amount of the repeating unit is preferably 90% by weight or more.

Preferably, the back sheet of the present invention has a maintenance ratio of elongation (%) (100×elongation after heat-treatment/elongation before heat-treatment) of 80% or more both in the longitudinal direction and transverse direction, when measured after heat-treatment for 75 hours using pressurized water under 2 atm at 120° C.

The polyester of the back sheet may further comprise a UV stabilizer and/or a UV absorbent, so as to improve UV stability/absorption. The type and mixing ratio of the UV stabilizer/absorbent may be selected without specific limitation in order to obtain desired UV stability/absorption based on their application. For example, benzotriazole-based compounds and HALS (hindered amine light stabilizer) compounds may be used as UV stabilizers, and hydroxybenzophenone and hydroxyphenyl benzotriazole may be used as UV absorbents. Preferably, these UV stabilizers/absorbents are comprised alone or mixed at an appropriate ratio in an amount of 0.01 to 1.0% by weight based on the polyester.

In addition, the back sheet of the present invention may be so prepared that it is transparent or it has a high reflection ratio. When it is used for a reflective layer, organic particles, alone or mixed, which are not compatible with inorganic particles or polyesters, may be added to the polyester of the back sheet so as to improve the reflection ratio of sunlight. For example, inorganic particles such as TiO₂ and BaSO₄ or organic particles such as cross-linked polymethamethylacrylate and cross-linked polystyrene may be added alone or in the form of a blend. Preferably, the amount of the inorganic particles is 0.01 to 15% by weight.

Also, the polyester of the back sheet may comprise a slip agent, in taking account of winding property or post-processability after heat-setting process. For example, inorganic or organic particles, preferably, inorganic particles such as silica gel, calcium carbonate and alumina having an average particle size of 0.1 to 10.0 μm may be comprised in an appropriate amount.

The back sheet of the present invention may be prepared by drawing in the longitudinal and transverse directions, sequentially or simultaneously.

Further, the back sheet may be prepared by a method comprising the step of drying a polyester resin which comprises at least one repeating unit of trimethylene naphthalate and trimethylene terephthalate in an amount of 85% by weight or more to reduce the moisture content to less than 50 ppm before melt-extrusion.

The polyester of the back sheet may comprise at least one additional repeating unit in an amount of 15% by weight or less. The additional repeating units may be selected without specific limitation but to the extent they do not adversely affect the crystallinity of the sheet due to increase of shrinkability after heat-set.

Preferably, the additional repeating unit is prepared by polymerizing at least one dibasic acid with at least one diol. The dibasic acid may be selected from the group consisting of isophthalic acid (IPA), succinic acid, glutaric acid, adipic acid, suberic acid, azelaic acid, sebacic acid and an ester derivative thereof. The diol may be selected from the group consisting of ethylene glycol (EG), diethylene glycol (DEG), neopentyl glycol (NPG), propylene glycol (PG), 1,4-butanediol (1,4-BDO), pentanediol, hexanediol, 2,2-butylethyl-1,3-propanediol (BEPD), 2-methyl-1,3-propanediol (MPDiol) and 1,4-cyclohexanedimethanol (1,4-CHDM).

The additional repeating units may be introduced to the polyester in the form of a copolymer or or a blend.

In accordance with another aspect of the present invention, there is provided a method for preparing a back sheet for a solar cell, comprising a) subjecting a polyester resin containing at least one repeating unit of trimethylene naphthalate and trimethylene terephthalate in an amount of 85% by weight or more to melt-extrusion and quenching, to obtain an undrawn sheet; b) drawing the undrawn sheet in the longitudinal and transverse directions and heat-set with relaxation to obtain a biaxially oriented sheet; and c) cooling the biaxially oriented sheet.

Preferably, the trimethylene terephthalate repeating unit is prepared by polymerizing 1,3-propanediol with terephthalic acid or a derivative thereof; and the trimethylene naphthalate repeating unit is prepared by polymerizing 1,3-propanediol with naphthalene dicarboxylic acid or a derivative thereof.

Preferably, step a) further comprises the step of drying the polyester resin to reduce the moisture content to less then 50 ppm before the melt-extrusion and quenching steps.

The sheet obtained in step c) may be used in itself as a back sheet for a solar cell, or may be subjected to an additional process. For example, the final sheet is further subjected to coating an ethylene vinyl acetate (EVA) layer on one side and a fluorine resin layer on the other side, in order to improve adhesion to a capsulant of a solar cell. Moreover, the final sheet may be coated with a transparent layer as a water barrier, on one side or both sides.

The back sheet for a solar cell according to the present invention has more improved hydrolysis-resistance than a conventional biaxially oriented polyethylene terephthalate (PET) film, so as to exhibit an enhanced weatherability which is required in a surface protective layer or a reflective layer of a solar cell. Further, the back sheet of the present invention may be further processed for various purposes, for example, it may be further coated with other films, or subjected to surface treatment or addition of UV stabilizer in a conventional manner.

The following Examples are given for the purpose of illustration only, and are not intended to limit the scope of the invention.

### Preparation Examples 1 To 5: Preparation of Polymers A To E

### Preparation Example 1

### Preparation of Polytrimethylene Terephthalate (PTT)—Polymer A

A reactor consisting of an esterification reactor (the first reactor) having a stirring rate of about 200 rpm and equipped with a separation tower for isolating 1,3-propanediol and water from a reaction mixture, an inverter agitator having a stirring rate of 50-10 rpm, a condenser for condensing of a reaction mixture, and a condensation polymerization reactor (the second reactor) equipped with a vacuum pump, was used.

Terephthalic acid was added to the first reactor, and 1,3-propanediol and tetrabutoxy titanate (TBT) diluted in n-butanol as a catalyst were added thereto in amounts of 120 parts by weight and 0.03 parts by weight, respectively, based on 100 parts by weight of terephthalic acid. The resulting mixture was allowed to react under about 1.2 kg/cm² at 260° C. for 4 hours with removing by-product, i.e., water.

After the esterification was complete, triethyl phosphate (TEP) as a stabilizer and silica particles having an average particle size of 2.5 μm as a slip agent were added thereto in amounts of 0.045 parts by weight and 0.07 parts by weight, respectively, based on 100 parts by weight of terephthalic acid, then the whole was stirred for 5 minutes.

The resulting mixture was transferred to the second reactor and allowed to polymerize at 270° C. under reduced pressure until the agitation motor reach to the predetermined electricity, to obtain polytrimethylene terephthalate as a pellet having an intrinsic viscosity (IV) of 0.870 dL/g.

### Preparation Example 2

### Preparation of Polytrimethylene Naphthalate (PTN)—Polymer B

The same reactor as that used in Preparation Example 1 was used.

Naphthalene dicarboxylate was added to the first reactor, and 1,3-propanediol and tetrabutoxy titanate (TBT) diluted in n-butanol as a catalyst were added thereto in amounts of 190 parts by weight and 0.03 parts by weight, respectively, based on 100 parts by weight of naphthalene dicarboxylate. The resulting mixture was allowed to react under about 1.2 kg/cm² at 170-230° C. for 4 hours with removing the by-product, i.e., methanol.

After the esterification was complete, triethyl phosphate (TEP) as a stabilizer and silica particles having an average particle size of 2.5 μm as a slip agent were added thereto in amounts of 0.045 parts by weight and 0.07 parts by weight, respectively, based on 100 parts by weight of naphthalene dicarboxylate, then the whole was stirred for 5 minutes.

The resulting mixture was transferred to the second reactor and allowed to polymerize at 280° C. under reduced pressure until agitation motor reach to the predetermined electricity, to obtain polytrimethylene naphthalate as a pellet having an intrinsic viscosity (IV) of 0.698 dL/g.

### Preparation Example 3

### Preparation of Polyethylene Naphthalate (PEN)—Polymer C

The procedures of Preparation Example 2 were repeated, except that ethylene glycol as a diol was added instead of 1,3-propanediol in an amount of 190 parts by weight based on 100 parts by weight of naphthalene dicarboxylate, and manganese acetate as an interesterification catalyst and antimony trioxide (Sb₂O₃) as a condensation polymerization catalyst (Sb₂O₃) were added in amounts of 0.04 parts by weight and 0.035 parts by weight, respectively, based on 100 parts by weight of naphthalene dicarboxylate.

As a result, polyethylene naphthalate having an intrinsic viscosity (IV) of 0.602 dL/g was obtained.

### Preparation Example 4

### Preparation of Polyethylene Terephthalate (PET)—Polymer D

The same reactor as that used in Preparation Example 1 was used.

Terephthalic acid was added to the first reactor, and ethylene glycol was added thereto in an amount of 120 parts by weight based on 100 parts by weight of terephthalic acid. The resulting mixture was allowed to react under about 1.2 kg/cm² at 260° C. for 4 hours with removing the by-product, i.e., water.

After the esterification was complete, antimony trioxide (Sb₂O₃) as a condensation polymerization catalyst and silica particles having an average particle size of 2.5 μm as a slip agent were added thereto in amounts of 0.035 parts by weight and 0.07 parts by weight, respectively, based on 100 parts by weight of terephthalic acid, then the whole was stirred for 5 minutes.

The resulting mixture was transferred to the second reactor and allowed to polymerize at 280° C. under reduced pressure until agitation motor reach to the predetermined electricity, to obtain polyethylene terephthalate as a pellet having an intrinsic viscosity (IV) of 0.605 dL/g.

### Preparation Example 5

### Preparation of Solid State Polymerized Polyethylene Terephthalate (SPET)—Polymer E

Polymer D obtained in Preparation Example 4 was subjected to a solid state polymerization at 220° C. under vacuum condition for 20 hours, to obtain solid state polymerized polyethylene terephthalate having an intrinsic viscosity of 0.802 dL/g.

### Examples 1 to 7 and Comparative Examples 1 to 5

### Preparation of Back Sheet of Solar Cell

Polymers A to E obtained in Preparation Examples 1 to 5 were mixed in various ratios as shown in Table 1. The resulting mixture was subjected to crystallization at 120° C. for 2 hours using a paddle dryer, and then dried at 165° C. for about 5 hours to reduce the moisture content to 50 ppm.

The each mixture was melted at a temperature range from Tm+20° C. to Tm+40° C., extruded through a T-die, and cooled by a casting roll kept at 18-20° C., to obtain an undrawn sheet.

The undrawn sheet was drawn in the longitudinal direction with 3-3.5 times using heating rolls having different peripheral velocities at a temperature range from Tg+5° C. to Tg+20° C., and then drawn in the transverse direction with 3.2-3.8 times using a tenter at a temperature range from Tg+20° C. to Tg+40° C., to obtain a biaxially oriented sheet.

Then, the biaxially oriented sheet was heat-set at a temperature range from Tm-50° C. to Tm-30° C. for several seconds, to obtain a back sheet for a solar cell having a thickness of 20-25 μm.

Each of the back sheets obtained in Examples 1 to 7 and Comparative Examples 1 to 5 was evaluated for the following properties, and the results are shown in Table 1.

### (1) Intrinsic Viscosity (IV)

The intrinsic viscosity was measured using a sheet sample which is dissolved in orthochlorophenol (OCP) at 30° C. according to a typical intrinsic viscosity measuring procedure of polyethylene terephthalate.

### (2) Hydrolysis-Resistance (Maintenance Ratio of Elongation, %)

A sheet sample (15 cm×15 cm) was placed in autoclave containing distilled water, which was pressurized with 2 atm of nitrogen gas to subject heat-treatment in distilled water at 120° C. for 75 hours.

The sheet sample was measured in terms of elongations before heat-treatment and after heat-treatment, in the longitudinal and transverse directions, with a universal tester. The each measurement was conducted for three times to take an average value. As a result, a maintenance ratio of elongation (%) was calculated using the following equation:

Maintenance ratio of elongation (%)=100×[elongation after heat-treatment]/[elongation before heat-treatment]

### (3) Elongation

The elongation at rupture was measured according to ASTM D 288 using a 100 mm×15 mm sheet sample at an elongation rate of 200 mm/min and an interval between chucks of 50 mm with a universal tester (UTM 4206-001, available from Instron Inc.)

TABLE 1

| | Composition (% by weight) | | | | | Hydrolysis-resistance | |
|---|---|---|---|---|---|---|---|
| | Polymer | Polymer | Polymer | Polymer | Polymer | (%) | |
| Example | A | B | C | D | E | Longitudinal | Transverse |
| No. | (PTT) | (PTN) | (PEN) | (PET) | (SPET) | direction | direction |
| Example 1 | 100 | — | — | — | — | 99 | 96 |
| Example 2 | 85 | — | 15 | — | — | 93 | 95 |
| Example 3 | — | 100 | — | — | — | 94 | 103 |
| Example 4 | 85 | — | — | — | 15 | 81 | 82 |
| Example 5 | — | 85 | 15 | — | — | 93 | 95 |
| Example 6 | — | 85 | — | — | 15 | 81 | 82 |
| Example 7 | 15 | 85 | — | — | — | 92 | 95 |
| Comparative | — | — | — | 100 | — | 43 | 7 |
| Example 1 | | | | | | | |
| Comparative | — | — | — | — | 100 | 78 | 65 |
| Example 2 | | | | | | | |
| Comparative | — | — | 80 | 20 | — | 46 | 41 |
| Example 3 | | | | | | | |
| Comparative | 80 | — | — | 20 | — | 48 | 38 |
| Example 4 | | | | | | | |
| Comparative | — | 80 | — | 20 | — | 61 | 43 |
| Example 5 | | | | | | | |

As shown in Table 1, the back sheets obtained in Examples 1 to 7 exhibit high hydrolysis-resistance. Accordingly, they are useful as a back sheet for a solar cell.

While the invention has been described with respect to the above specific embodiments, it should be recognized that various modifications and changes may be made to the invention by those skilled in the art which also fall within the scope of the invention as defined by the appended claims.

What is claimed is:

1. A back sheet for a solar cell, consisting of a polyester comprising at least one repeating unit of trimethylene naphthalate and trimethylene terephthalate in an amount of 85% by weight or more.

2. The back sheet for a solar cell of claim 1, which has a maintenance ratio of elongation (%) (100×elongation after heat-treatment/elongation before heat-treatment) of 80% or more both in the longitudinal and transverse directions, when measured after heat-treatment for 75 hours using pressurized water under 2 atm at 120° C.

3. The back sheet for a solar cell of claim 1, wherein the polyester further comprises at least one of a UV stabilizer and a UV absorbent in an amount of 0.01 to 1.0% by weight.

4. The back sheet for a solar cell of claim 3, wherein the UV stabilizer is a benzotriazole-based compound or a HALS (hindered amine light stabilizer) compound and the UV absorbent is hydroxybenzophenone or hydroxyphenyl benzotriazole.

5. The back sheet for a solar cell of claim 1, wherein the polyester further comprises inorganic particles in an amount of 0.01 to 15% by weight.

6. The back sheet for a solar cell of claim 1, which is prepared by a method comprising the step of drying a polyester resin which comprises at least one repeating unit of trimethylene naphthalate and trimethylene terephthalate in an amount of 85% by weight or more to reduce the moisture content to less than 50 ppm before melt-extrusion.

7. The back sheet for a solar cell of claim 1, wherein the polyester comprises at least one additional repeating unit prepared by polymerizing (i) at least one dibasic acid selected from the group consisting of isophthalic acid (IPA), succinic acid, glutaric acid, adipic acid, suberic acid, azelaic acid, sebacic acid, and an ester derivative thereof; with (ii) at least one diol selected from the group consisting of ethylene glycol (EG), diethylene glycol (DEG), neopentyl glycol (NPG), propylene glycol (PG), 1,4-butanediol (1,4-BDO), pentanediol, hexanediol, 2,2-butylethyl-1,3-propanediol (BEPD), 2-methyl-1,3-propanediol (MPDiol), and 1,4-cyclohexanedimethanol (1,4-CHDM), in an amount of 0.01 to 15% by weight.

8. A method for preparing a back sheet for a solar cell, comprising the steps of:
a) subjecting a polyester resin containing at least one repeating unit of trimethylene naphthalate and trimethylene terephthalate in an amount of 85% by weight or more to melt-extrusion and quenching, to obtain an undrawn sheet;
b) drawing the undrawn sheet in the longitudinal and transverse directions and heat-set with relaxation to obtain a biaxially oriented sheet; and
c) cooling the biaxially oriented sheet.

9. The method for preparing a back sheet for a solar cell of claim 8, wherein the trimethylene terephthalate repeating unit is prepared by polymerizing 1,3-propanediol with terephthalic acid or a derivative thereof; and the trimethylene naphthalate repeating unit is prepared by polymerizing 1,3-propanediol with naphthalene dicarboxylic acid or a derivative thereof.

10. The method for preparing a back sheet for a solar cell of claim 8, wherein step a) further comprises the step of drying the polyester resin to reduce the moisture content to less then 50 ppm before the melt-extrusion and quenching steps.

11. The method for preparing a back sheet for a solar cell of claim 8, wherein step c) further comprises the step of coating one side of the final sheet with an ethylene vinyl acetate (EVA) layer and the other side of the sheet with a fluorine resin layer.
